(19) United States
(12) Patent Application Publication
(10) Pub. No.: US 2023/0336406 A1
(43) Pub. Date: Oct. 19, 2023

(54) COMMUNICATION CONTROL DEVICE, COMMUNICATION SYSTEM, COMMUNICATION CONTROL METHOD, AND PROGRAM

(71) Applicant: NIPPON TELEGRAPH AND TELEPHONE CORPORATION, Tokyo (JP)

(72) Inventors: Ayako IWAKI, Musashino-shi, Tokyo (JP); Hideaki KIMURA, Musashino-shi, Tokyo (JP); Tomoya KOSUGI, Musashino-shi, Tokyo (JP)

(73) Assignee: NIPPON TELEGRAPH AND TELEPHONE CORPORATION, Tokyo (JP)

(21) Appl. No.: 18/026,109

(22) PCT Filed: Sep. 16, 2020
(86) PCT No.: PCT/JP2020/035116

§ 371 Date: Mar. 13, 2023

(51) Int. Cl. H04L 41/0663

(52) U.S. Cl. CPC H04L 41/0663

(57) ABSTRACT

An object of the present invention is to provide a communication control device that can implement a redundant configuration of Act/Standby that does not require advanced control, at low cost, and is capable of high-speed switching in both switching from an active system to a standby system and switch-back from the standby system to the active system.

A communication control device according to the present invention includes: a detection unit 51 that detects alarm information on failure or recovery of the active system and the standby system; an operation state storage unit 56 that stores a communication state at present after a communication control function unit 16 has made transition of the communication state; a control determination unit 52 that determines the communication state that is new in a subscriber router PE1 on the basis of the alarm information detected by the detection unit 51 and information on the communication state stored in the operation state storage unit 56; a switching setting unit 53 that sets the communication state that is new determined by the control determination unit 52 for the communication control function unit 16; and a state transition recording unit 55 that stores the communication state that is new determined by the control determination unit 52 in the operation state storage unit 56.

### TECHNICAL FIELD

The present disclosure relates to a communication control device, a communication system, a communication control method, and a program that implement a redundancy switching function of an access section in an L2VPN system.

### BACKGROUND ART

With spread of Ethernet Virtual Private Network (EVPN) (RFC7432; Non Patent Literature 1), it is considered to apply the EVPN to a wide area Ethernet (L2VPN) service.

There is a demand for implementing a redundant configuration of an access section at low cost in addition to a relay section, from users such as corporations having strict quality requirements for network (NW) services.

FIGS. 1 and 2 each are a diagram illustrating a communication system in which an access section is made redundant. FIG. 1 illustrates a form in which redundancy is configured with two subscriber routers (device redundancy), and FIG. 2 illustrates a form in which there is one subscriber router but redundancy is configured with two line cards (line card redundancy). The communication system in FIGS. 1 and 2 includes a relay network (the Internet) 200, an access section 201 connecting the relay network 200 to a user-side boundary router CE1, and a subscriber router PE1 connecting the relay network 200 to the access section 201. In the case of FIG. 1, the access section is made redundant with two subscriber routers (PE1m, PE1s). In the case of FIG. 2, the subscriber router PE1 includes two line cards (LCm, LCs), and the access section is made redundant with the two line cards. In addition, a user-side boundary router CE2 is connected to the relay network 200 via a subscriber router PE2 facing the user-side boundary router CE1.

The user-side boundary router (CE1, CE2) is a boundary router that connects a network of a user and an operator network to each other. An L2 frame is transmitted and received to and from the subscriber router (PE1, PE2).

The subscriber router (PE1, PE2) encapsulates the L2 frame received from the user-side boundary router (CE1, CE2) into an L3 packet and transfers the L3 packet to the relay network 200, and extracts the L2 frame encapsulated in the L3 packet received from the relay network 200 and transmits the L2 frame to the user-side boundary router (CE1, CE2). In a case where the access section 201 is made redundant, a redundant configuration is made on the user-side boundary router side from the subscriber router. FIG. 1 is a form of device redundancy, and FIG. 2 is a form of line card redundancy. The line card redundancy is a redundant configuration in which the subscriber router PE1 is a chassis type housing and ports of an active system and a standby system are selected from different line cards (LEm, LCs).

The relay network 200 is a network that transfers the L2 frame encapsulated in the subscriber router PE1 (or PE2) to the subscriber router PE2 (or PE1) at a base of each user by using a layer 3 technology. The relay network 200 implements high-speed redundancy switching of the access section 201 in a MAC address advertisement using BGP of EVPN.

FIG. 3 is a functional block configuration diagram illustrating the subscriber router PE. In the figure, only functions related to access accommodation are described. The subscriber router (PE1, PE2) includes:
a CE-side physical interface 11;
a sub-interface 12 that separates the L2 frame input from the CE-side physical interface 11 for each VLAN and serves as a boundary for a frame input of each VLAN;
a bridge domain 13 that makes point-to-multipoint connection of the VLAN caused to branch by the sub-interface 12;
an encapsulation function unit 14 for encapsulating the L2 frame merged in the bridge domain 13 into an L3 packet for transferring in the relay network 200; and
a relay-network-side physical interface 15 that transmits an L3 frame generated by the encapsulation function unit 14 to the relay network 200.

### CITATION LIST

### Patent Literature

Patent Literature 1: JP 2009-194622 A

### Non Patent Literature

Non Patent Literature 1: rfc7432, “BGP MPLS-Based Ethernet VPN”
Non Patent Literature 2: IEEE Std802.1AX-2008, “Link Aggregation”

### SUMMARY OF INVENTION

### Technical Problem

A device and a method for making an access section redundant are disclosed (see, for example, Patent Literature 1.). However, in the device and method of Patent Literature 1, it is necessary to install a dedicated access device even though long-distance transmission is unnecessary, such as a case where the subscriber router PE and the user-side boundary router CE are in the same base due to collocation or the like. That is, the device and the method of Patent Literature 1 require installation of a dedicated access device regardless of the transmission distance, and there is a problem that cost reduction is difficult.

Meanwhile, Non Patent Literature 2 discloses a link aggregation (LAG) function of a redundancy means. If the LAG function is used, a dedicated access device as in Patent Literature 1 becomes unnecessary. However, to perform redundancy with the LAG function, the LAG function is required in the user-side boundary router CE, and consistency of LAG operation is required between the user-side boundary router CE and the subscriber router PE.

As a more general LAG function, frame transmission and reception can be performed from both the active system subscriber router PE1m and the standby system subscriber router PE1s, but in this state, when the amount of traffic flowing through both systems are summed up, traffic greater than or equal to the contract flows in the access section. In particular, in the case of device redundancy as illustrated in FIG. 1, both the active system subscriber router PE1m and the standby system subscriber router PE1s need to cooperate to perform band limitation to keep the total traffic flowing through both systems within the contract band.

That is, in a case where redundancy is performed with the LAG function, there is a problem that cost reduction is difficult since the LAG function is also arranged in the user-side boundary router CE and more advanced control is required.

Here, to avoid the bandwidth control, it is necessary to cause traffic to flow through either the active system or the standby system (redundancy switching). Here, the EVPN has a function called multi-homing, and this function can be used to implement redundancy switching.

In multi-homing, three implementation patterns of All-active, Single-active, and Port-active are defined by RFC (Port-active is not currently supported). All-active configures a redundant system by Act/Act (causing traffic to flow through both paths), and Single-active configures a redundant system by Act/Standby (causing traffic to flow through one path).

When the active system is switched to the standby system, high-speed switching is possible for both All-active and Single-active. However, in the case of switch-back from the standby system to the active system, All-active can be switched in the time equivalent to that of switching from the active system to the standby system, but the switching time of Single-active becomes long. This is because it is necessary to provide a protection time of several seconds until the active system router actually operates as a Designated Forwarder (hereinafter, DF) that is the transmission destination of BUM traffic after the notification that the active system router is re-selected is transmitted to the DF. Thus, in the case of Single-active, signal disconnection occurs during this protection time.

For this reason, if a redundant switching system is to be configured by using only EVPN multi-homing, there is a problem that it is difficult to avoid signal disconnection in a case where an Act/Standby redundant system is configured in Single-active. If a redundant system capable of avoiding signal disconnection is to be configured by using only EVPN multi-homing, the system is configured in All-active, and in this case, it is necessary to make connection between the PE and the CE by Link aggregation to avoid a loop. That is, to form the redundant system capable of avoiding signal disconnection by using only EVPN multi-homing, advanced control of the Link aggregation described above is required, and a problem that cost reduction is difficult occurs.

Thus, to solve the above-described problems, an object of the present invention is to provide a communication control device, a communication system, a communication control method, and a program that can implement a redundant configuration of Act/Standby that does not require advanced control, at low cost, and is capable of high-speed switching in both switching from the active system to the standby system and switch-back from the standby system to the active system.

### Solution to Problem

To achieve the above object, a communication control device according to the present invention instructs a communication control function unit of a subscriber router to cause traffic to flow or to be stopped.

Specifically, the communication control device according to the present invention is A communication control device that controls a subscriber router that makes an access section between a relay network and a user device redundant with an active system and a standby system,
the communication control device including,
in order to cause a communication control function unit to perform transition of a communication state, in the subscriber router, the communication control function unit grasping the communication state between the active system and the standby system and also opening or closing the active system and opening or closing the standby system to perform the transition of the communication state,
a detection unit that detects alarm information on failure or recovery of the active system and the standby system,
an operation state storage unit that stores the communication state at present after the communication control function unit has made the transition of the communication state,
a control determination unit that determines the communication state that is new in the subscriber router on the basis of the alarm information detected by the detection unit and information on the communication state stored in the operation state storage unit,
a switching setting unit that sets the communication state that is new determined by the control determination unit for the communication control function unit, and
a state transition recording unit that stores the communication state that is new determined by the control determination unit in the operation state storage unit.

In addition, a communication system according to the present invention includes the communication control device and the subscriber router.

Furthermore, a communication control method according to the present invention is a communication control method for controlling a subscriber router that makes an access section between a relay network and a user device redundant with an active system and a standby system,
the communication control method including,
in order to cause a communication control function unit to perform transition of a communication state, in the subscriber router, the communication control function unit grasping the communication state between the active system and the standby system and also opening or closing the active system and opening or closing the standby system to perform the transition of the communication state,
detecting alarm information on failure or recovery of the active system and the standby system,
determining the communication state that is new in the subscriber router on the basis of the alarm information and information on the communication state at present stored in an operation state storage unit,
setting the communication state that is new for the communication control function unit, and
storing the communication state that is new in the operation state storage unit.

The communication control function unit of the subscriber router can perform interruption and communication (shutdown/no shutdown) of traffic in accordance with an instruction from the communication control device even if the subscriber router is in a state of allowing traffic to flow. That is, the communication control function unit can perform switching between shutdown and no shutdown in conjunction with movement on the relay network side (for example, a PE switching notification of EVPN multi-homing, and a reception timing of a user frame or BUM traffic from an opposite base). Thus, the communication control device can perform control to avoid signal disconnection at the time of switching from the standby system to the active system as much as possible.

In addition, the communication control device can be implemented at a lower cost than the device as disclosed in Patent Literature 1.

Thus, the present invention can provide a communication control device, a communication system, and a communication control method that can implement a redundant configuration of Act/Standby that does not require advanced control, at low cost, and is capable of high-speed switching in both switching from the active system to the standby system and switch-back from the standby system to the active system.

The communication control device according to the present invention
may further include
an error detection unit that detects an error during the transition of the communication state performed by the communication control function unit, and
a switch-back setting unit that performs setting on the communication control function unit when the error is detected to restore the communication state that is new to the communication state that is an original state.

The communication control device according to the present invention may further include an instruction receiving unit that instructs the switching setting unit to perform setting to restore the communication state transitioned, to an original state when an instruction signal externally input is received.

The present invention is a program for causing a computer to function as the communication control device. The communication control device according to the present invention can also be implemented by a computer and a program, and the program can be recorded in a recording medium or provided through a network.

Note that the inventions described above can be combined as far as possible.

### Advantageous Effects of Invention

The present invention can provide a communication control device, a communication system, a communication control method, and a program that can implement a redundant configuration of Act/Standby that does not require advanced control, at low cost, and is capable of high-speed switching in both switching from the active system to the standby system and switch-back from the standby system to the active system.

The present invention allows traffic to flow through one system (active system or standby system) without performing complicated control for band limitation.

### BRIEF DESCRIPTION OF DRAWINGS

FIG. 1 is a diagram for explaining a communication system in which an access section is made redundant.

FIG. 2 is a diagram for explaining a communication system in which an access section is made redundant.

FIG. 3 is a functional block configuration diagram illustrating a subscriber router.

FIG. 4 is a functional block configuration diagram illustrating a subscriber router of a communication system according to the present invention.

FIG. 5 is a diagram illustrating the communication system according to the present invention.

FIG. 6 is a diagram for explaining a communication control device according to the present invention.

FIG. 7 is a diagram illustrating a communication control method according to the present invention.

FIG. 8 is a diagram illustrating communication states and state transitions of an active system and a standby system in the communication system according to the present invention.

FIG. 9 is a diagram for explaining a communication control device according to the present invention.

FIG. 10 is a diagram illustrating a communication control method according to the present invention.

FIG. 11 is a diagram for explaining a communication control device according to the present invention.

FIG. 12 is a diagram illustrating a communication control method according to the present invention.

FIG. 13 is a diagram illustrating communication states and state transitions of the active system and the standby system in the communication system according to the present invention.

FIG. 14 is a diagram for explaining operation of the communication system according to the present invention.

FIG. 15 is a diagram for explaining operation of the communication system according to the present invention.

FIG. 16 is a diagram for explaining operation of the communication system according to the present invention.

FIG. 17 is a diagram for explaining operation of the communication system according to the present invention.

FIG. 18 is a diagram for explaining operation of the communication system according to the present invention.

FIG. 19 is a diagram for explaining operation of the communication system according to the present invention.

FIG. 20 is a diagram for explaining operation of the communication system according to the present invention.

FIG. 21 is a diagram for explaining operation of the communication system according to the present invention.

FIG. 22 is a diagram for explaining operation of the communication system according to the present invention.

FIG. 23 is a diagram for explaining operation of the communication system according to the present invention.

FIG. 24 is a diagram for explaining operation of the communication system according to the present invention.

FIG. 25 is a diagram for explaining operation of the communication system according to the present invention.

FIG. 26 is a diagram for explaining a communication control device according to the present invention.

### DESCRIPTION OF EMBODIMENTS

Embodiments of the present invention will be described with reference to the accompanying drawings. The embodiments described below are examples of the present invention, and the present invention is not limited to the following embodiments. Note that components having the same reference signs in the present description and the drawings indicate the same components.

[Point of Invention]

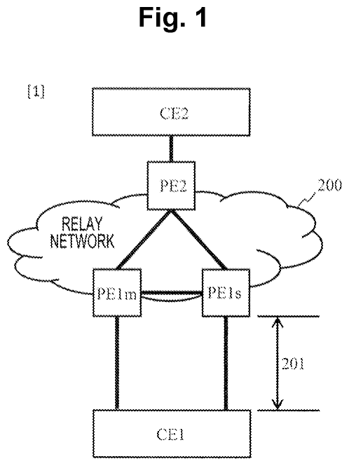

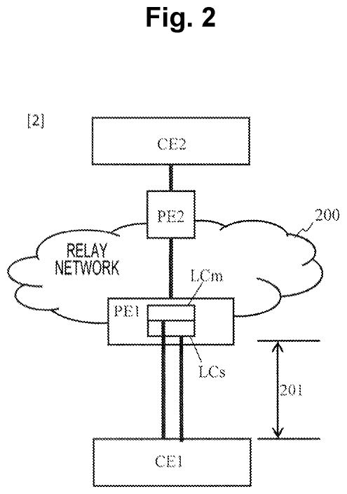

A communication system of the present embodiment is similar to the configurations of the communication systems described in FIGS. 1 and 2. In the present embodiment, only differences from the communication system described in FIGS. 1 and 2 will be described.

(Difference 1)

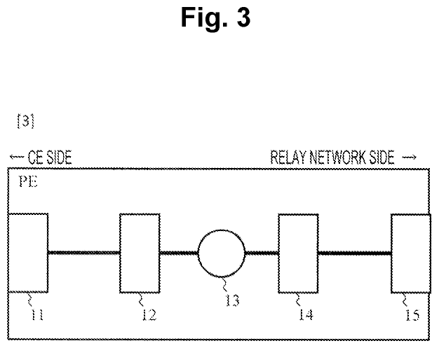

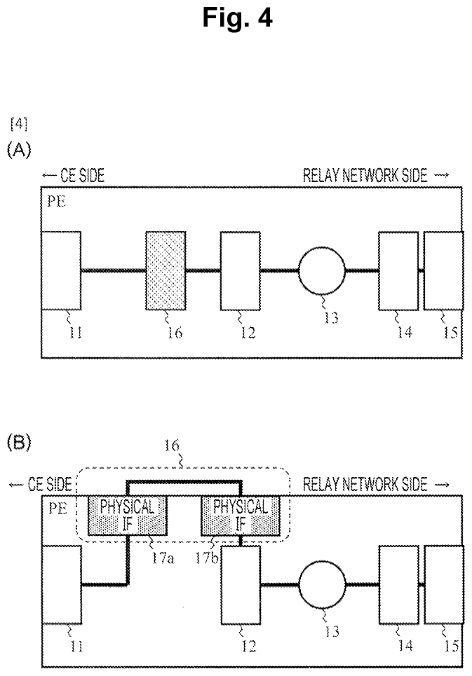

FIG. 4(A) is a diagram illustrating a subscriber router of the communication system of the present embodiment. In the figure, only functions related to access accommodation are described. The subscriber router of the present embodiment includes, between the sub-interface 12 of the subscriber router PE and the CE-side physical interface 11, a communication control function unit 16 that stops communication of links configuring the redundant system of the access section 201 with respect to the subscriber router described in FIG. 3.

A bridge connection is made between the communication control function unit 16 and the CE-side physical interface 11 in the subscriber router PE. The communication control function unit 16 is implemented in a commercial product subscriber router in a logical interface or another form that can be set in the router.

In a case where the communication control function unit that can make a bridge connection to the CE-side physical interface 11 cannot be set inside the subscriber router PE, a form as illustrated in FIG. 4(B) may be adopted. That is, a connection is made between two physical interfaces (17a, 17b) outside the housing of the subscriber router PE, to connect the sub-interface 12 and the CE-side physical interface 11 to each other. Then, by turning on/off the connection, it is possible to substitute the communication control function unit 16.

In a case where the CE-side physical interface 11 is directly shut down as in Single-active of multi-homing, normality of a connection between the subscriber router PE and the user boundary router CE cannot be confirmed from the user-side boundary router CE. However, in the configuration as illustrated in FIG. 4, since the CE-side physical interface 11 is not directly shut down, the normality of the connection between the subscriber router PE and the user boundary router CE can be confirmed from the user-side boundary router CE, and communication of a frame of the link can be stopped. That is, it is possible to implement a communication state equivalent to that in Single-active while being in All-active of multi-homing.

(Difference 2)

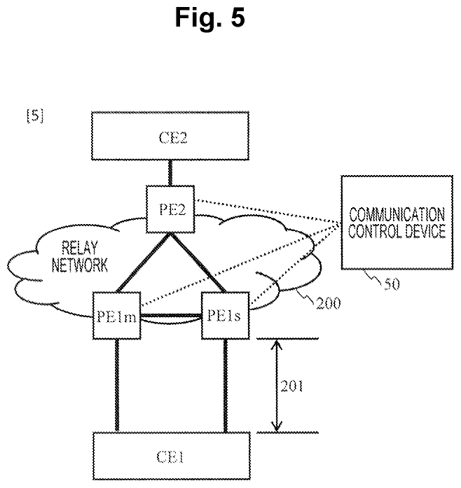

FIG. 5 is a diagram illustrating the communication system of the present embodiment. The communication system of the present embodiment includes a communication control device 50 to be described later and the subscriber router PE in FIG. 4.

Similarly to the communication system described in FIG. 1, the communication system of the present embodiment configures a redundant system by bridging. Here, an example of device redundancy will be described, but the same applies to line card redundancy. The communication system of the present embodiment further includes the communication control device 50 with respect to the communication system described in FIG. 1. The communication system of the present embodiment uses the communication control device 50 to open/close the communication control function unit 16 of the subscriber router PE in conjunction with switching between an active system and a standby system, thereby avoiding a loop of a frame. The communication control device 50 controls opening/closing of the communication control function units 16 of an active system PE1m and a standby system PE1s with a failure notification of each PE as a trigger.

The communication control device 50 has the following forms.
(i) As illustrated in FIG. 5, the communication control device 50 is a unique device connected to the management port of the subscriber router PE configuring the redundant system.
(ii) This is implemented by an operation system (OpS) including a function of the communication control device 50 described above.
(iii) The function of the communication control device 50 is implemented in the subscriber router PE in a manner of implementing a D-plane function and a C-plane function in the same device by Network Functions Virtualisation (NFV) or the like.

The communication system of the present embodiment includes the communication control device 50, thereby being able to implement closing/opening of the communication control function unit 16 in conjunction with switching operation between the active system and the standby system regardless of a function of the subscriber router PE.

### First Embodiment

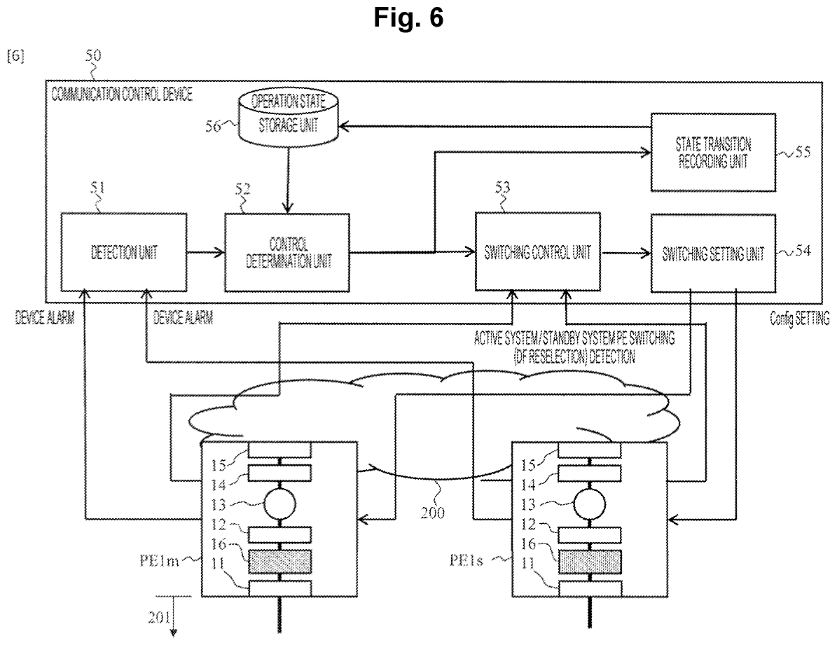

FIG. 6 is a diagram for explaining a communication control device 50 of the present embodiment. The communication control device 50 is a communication control device that controls a subscriber router (PE1m, PE1s) that makes an access section 201 between a relay network 200 and a user device redundant with an active system and a standby system,
the communication control device 50 including,
in order to cause a communication control function unit 16 to perform transition of a communication state, in the subscriber router, the communication control function unit 16 grasping the communication state between the active system and the standby system and also opening or closing the active system and opening or closing the standby system to perform the transition of the communication state,
a detection unit 51 that detects alarm information on failure or recovery of the active system and the standby system,
an operation state storage unit 56 that stores the communication state at present after the communication control function unit 16 has made the transition of the communication state,
a control determination unit 52 that determines the communication state that is new in the subscriber router (PE1m, PE1s) on the basis of the alarm information detected by the detection unit 51 and information on the communication state stored in the operation state storage unit 56,
a switching setting unit 53 that sets the communication state that is new determined by the control determination unit 52 for the communication control function unit 16, and
a state transition recording unit 55 that stores the communication state that is new determined by the control determination unit 52 in the operation state storage unit 56.

The detection unit 51 detects failure or recovery of a CE-side physical interface 11. For example, the detection unit 51 detects a logical failure and alarm cancellation by a physical failure or an OAM alarm, and uses the logical failure and the alarm cancellation as a switching trigger between the active system and the standby system.

The operation state storage unit 56 stores a current state of a state transition to be described later.

The control determination unit 52 determines which of the communication control function unit 16 of the subscriber router PE1m or the communication control function unit 16 of the subscriber router PE1s is to be shut down (the other is not shut down) on the basis of the alarm information detected by the detection unit 51 and the information of the operation state storage unit 56.

In the case of the redundant system of device redundancy by EVPN multi-homing, the switching setting unit 53 needs to match timings of DF selection of the active system and the standby system and switching between the active system and the standby system to avoid signal disconnection. The switching setting unit 53 detects that a DF is selected by the subscriber router PE1m and the subscriber router PE1s, and transfers a result by the control determination function unit 52 to the switching setting unit 54. Since there is no DF selection in the case of line card redundancy, the switching setting unit 53 immediately transfers the result by the control determination unit 52 to the switching setting unit 54.

The switching setting unit 54 sets shutdown/no shutdown on the communication control function units 16 of the subscriber router PE1m and the subscriber router PE1s on the basis of determination by the control determination unit 53 (Config setting).

The state transition recording unit 55 stores a determination result (next state) by the control determination unit 52 in the operation state storage unit 56.

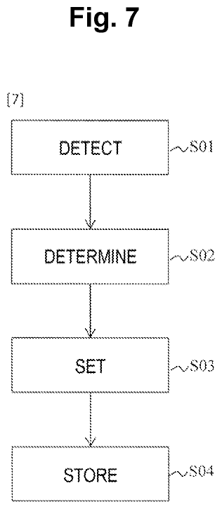

FIG. 7 is a diagram for explaining a communication control method performed by the communication control device 50 of FIG. 6. The communication control method is a communication control method for controlling a subscriber router that makes an access section between a relay network and a user device redundant with an active system and a standby system,
the communication control method including,
in order to cause a communication control function unit to perform transition of a communication state, in the subscriber router, the communication control function unit grasping the communication state between the active system and the standby system and also opening or closing the active system and opening or closing the standby system to perform the transition of the communication state,
detecting alarm information on failure or recovery of the active system and the standby system (step S01),
determining the communication state that is new in the subscriber router on the basis of the alarm information and information on the communication state at present stored in an operation state storage unit (step S02),
setting the communication state that is new for the communication control function unit (step S03), and
storing the communication state that is new in the operation state storage unit (step S04).

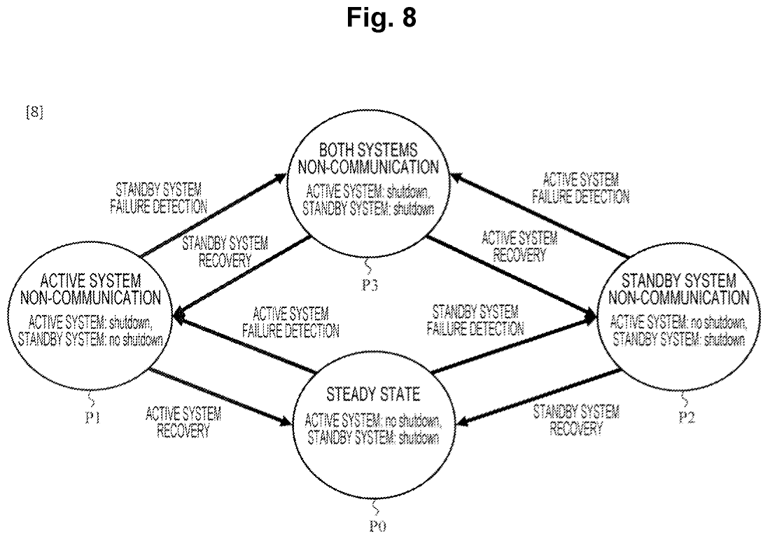

FIG. 8 is a diagram illustrating communication states and state transitions of the communication control function units 16 of the subscriber router PE1m and the subscriber router PE1s.

In a steady state P0, the communication control function unit 16 of the subscriber router PE1m that is the active system is in a no shutdown state, and the communication control function unit 16 of the subscriber router PE1s that is the standby system is in a shutdown state.

In a case where a failure of the active system is detected in the steady state P0, the state transitions from the steady state P0 to an active system non-communication state P1. In the active system non-communication state P1, the communication control function unit 16 of the subscriber router PE1m that is the active system is in the shutdown state, and the communication control function unit 16 of the subscriber router PE1s that is the standby system is in the no shutdown state. In a case where recovery of the active system is detected in the active system non-communication state P1, the state transitions from the active system non-communication state P1 to the steady state P0.

In a case where a failure of the standby system is detected in the steady state P0, the state transitions from the steady state P0 to a standby system non-communication state P2. In the standby system non-communication state P2, the communication control function unit 16 of the subscriber router PE1m that is the active system is in the no shutdown state, and the communication control function unit 16 of the subscriber router PE1s that is the standby system is in the shutdown state. In a case where recovery of the standby system is detected in the standby system non-communication state P2, the state transitions from the standby system non-communication state P2 to the steady state P0.

In a case where a failure of the standby system is detected in the active system non-communication state P1 or in a case where a failure of the active system is detected in the standby system non-communication state P2, the state transitions from the active system non-communication state P1 or the standby system non-communication state P2 to a both systems non-communication state P3. In the both systems non-communication state P3, the communication control function unit 16 of the subscriber router PE1m that is the active system is in the shutdown state, and the communication control function unit 16 of the subscriber router PE1s that is the standby system is also in the shutdown state. In a case where recovery of the standby system is detected in the both systems non-communication state P3, the state transitions from the both systems non-communication state P3 to the active system non-communication state P1. On the other hand, in a case where recovery of the active system is detected in the both systems non-communication state P3, the state transitions from the both systems non-communication state P3 to the standby system non-communication state P2.

### Second Embodiment

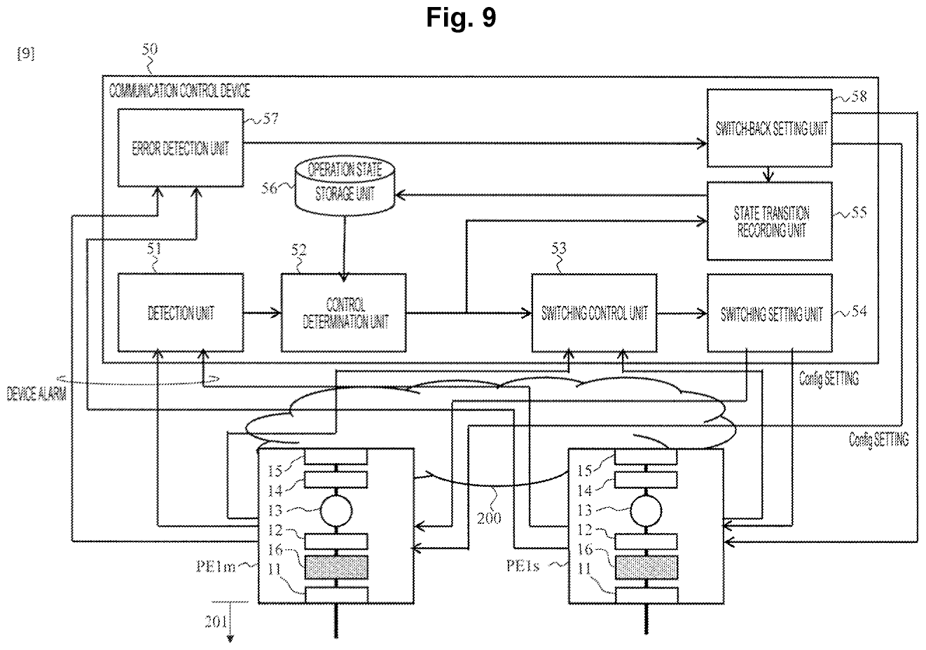

FIG. 9 is a diagram for explaining a communication control device 50 of the present embodiment. In the present embodiment, a function is added of restoring setting of the communication control function unit 16 in a case where there is some error during the setting of the closing/opening by the communication control function unit 16. The communication control device 50 further includes,
in the communication control device 50 described in the first embodiment,
an error detection unit 57 that detects an error during the transition of the communication state performed by the communication control function unit 16, and
a switch-back setting unit 58 that performs setting on the communication control function unit 16 when the error is detected to restore the communication state that is new to the communication state that is an original state.

Note that the “switch-back” is operation of restoring a current state of a redundant system to an original state.

Here, a description will be given of only functions different from those of the communication control device 50 of the first embodiment.

In a case where an error occurs while the communication control function unit 16 is setting shutdown/no shutdown, the error detection unit 57 detects the error. For example, when switching of a redundant system is to be performed, there may be a case where the switching cannot be performed or the switching can be performed but the switch-back automatically occurs instantly (the original state is restored).

The switch-back setting unit 58 performs switch-back setting on the communication control function unit 16 (Config setting). With this setting, a state of the redundant system is recovered to a state before the state transition is attempted.

Note that the switch-back setting unit 58 notifies the state transition recording unit 55 that the setting has been switched back (that the state transition has not been performed). Since there is no state transition, the state transition recording unit 55 does not store the determination result (next state) by the control determination unit 52 in the operation state storage unit 56.

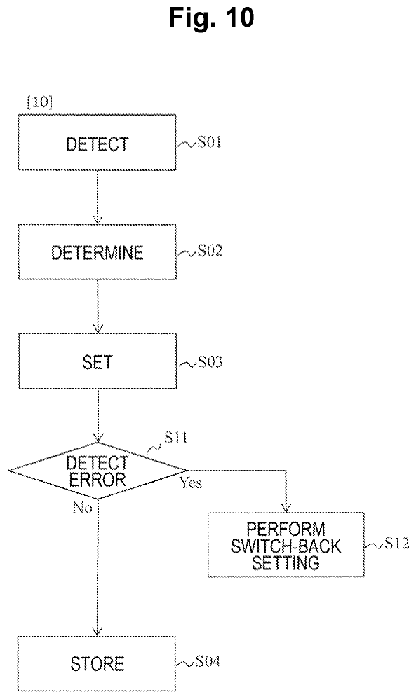

FIG. 10 is a diagram for explaining a communication control method performed by the communication control device 50 of FIG. 9. In the communication control method, step S11 and step S12 are added to the method described in FIG. 7. That is, the communication control method further includes: detecting an error during the transition of the communication state performed by the communication control function unit 16 (step S11); and performing setting on the communication control function unit 16 when the error is detected (“Yes” in step S11) to restore the communication state that is new to the communication state that is an original state (step S12).

Note that when the error is not detected (“No” in step S11), step S04 is performed as described in FIG. 7.

### Third Embodiment

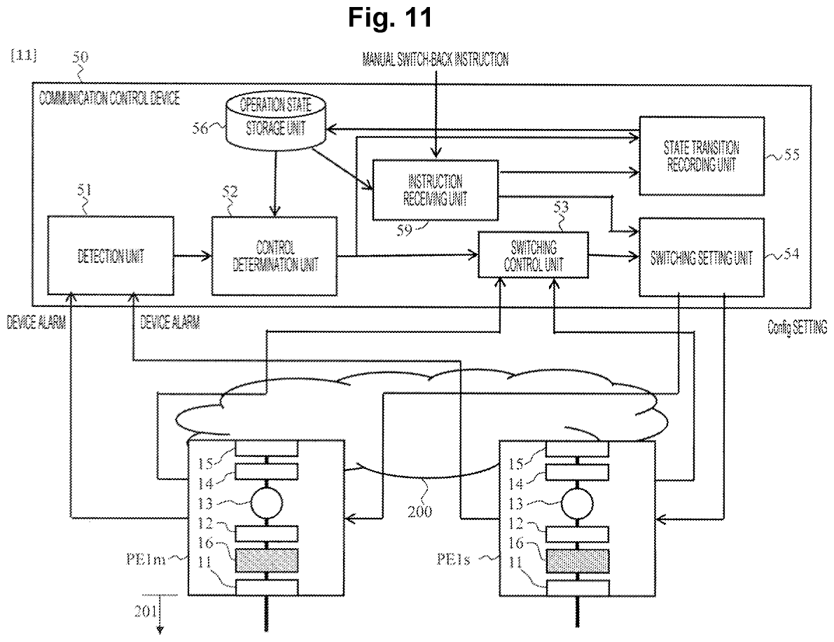

FIG. 11 is a diagram for explaining a communication control device 50 according to the present embodiment. In the present embodiment, a function is added of manually restoring the setting of the communication control function unit 16. The communication control device 50 further includes an instruction receiving unit 59 that instructs the switching setting unit 54 to perform setting to restore the communication state transitioned, to an original state when an instruction signal externally input is received, in the communication control device 50 described in the first embodiment.

Here, a description will be given of only functions different from those of the communication control device 50 of the first embodiment.

The instruction receiving unit 59 receives a manual switch-back command from a worker or the like. Then, when receiving the command, the instruction receiving unit 59 confirms all the communication states stored in the operation state storage unit 56, and instructs the switching setting unit 54 to perform setting to be in a desired communication state (a switch-back state requested by the command). The switching setting unit 54 sets shutdown/no shutdown for the communication control function units 16 of the subscriber router PE1m and the subscriber router PE1s in accordance with the instruction (Config setting).

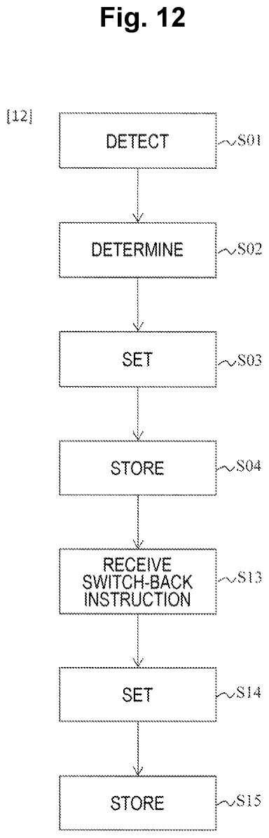

FIG. 12 is a diagram for explaining a communication control method performed by the communication control device 50 of FIG. 11. In the communication control method, steps S13 to S15 are added to the method described in FIG. 7. That is, the communication control method further includes performing setting to restore the communication state transitioned, to an original state (step S14) when an instruction signal externally input is received (step S13). Then, the state after the switch-back is stored in the operation state storage unit 56 (step S15).

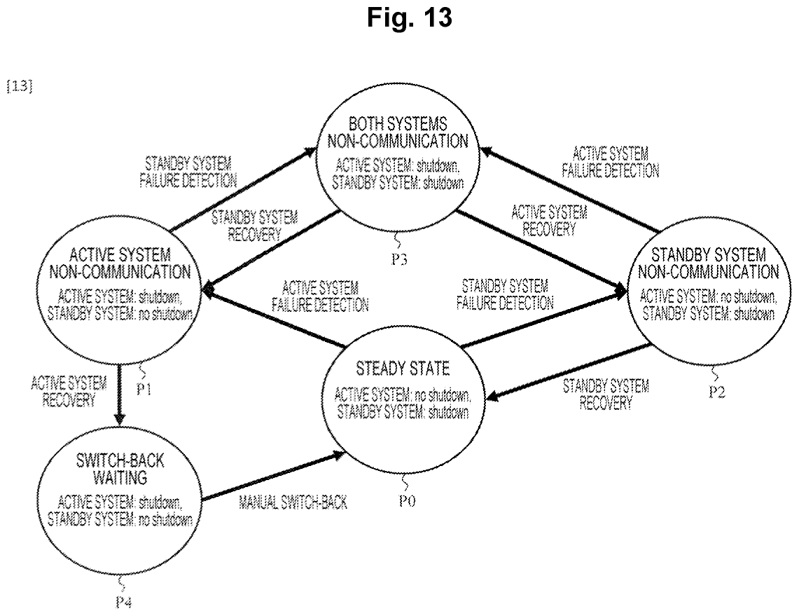

FIG. 13 is a diagram illustrating communication states and state transitions of the communication control function units 16 of the subscriber router PE1m and the subscriber router PE1s in the present embodiment. A manual switch-back waiting state P4 is newly added to the states of FIG. 8. In the present embodiment, in a case where the active system is recovered in the state P1, the state P1 does not automatically restored to the state P0. In the present embodiment, in a case where the active system is recovered in the state P1, the state transitions to the switch-back waiting state P4 in which the communication control function unit 16 of the subscriber router PE1m that is the active system maintains the shutdown state, and the communication control function unit 16 of the subscriber router PE1s that is the standby system maintains the no shutdown state. Thereafter, when the instruction receiving unit 59 receives a manual switch-back instruction from the outside, the state transitions from the switch-back waiting state P4 to the steady state P0.

Linkage operation between the communication control device 50 and the relay network 200 will be described below.

### Example 1

This example is a case of transition from the state P0 to the state P1.

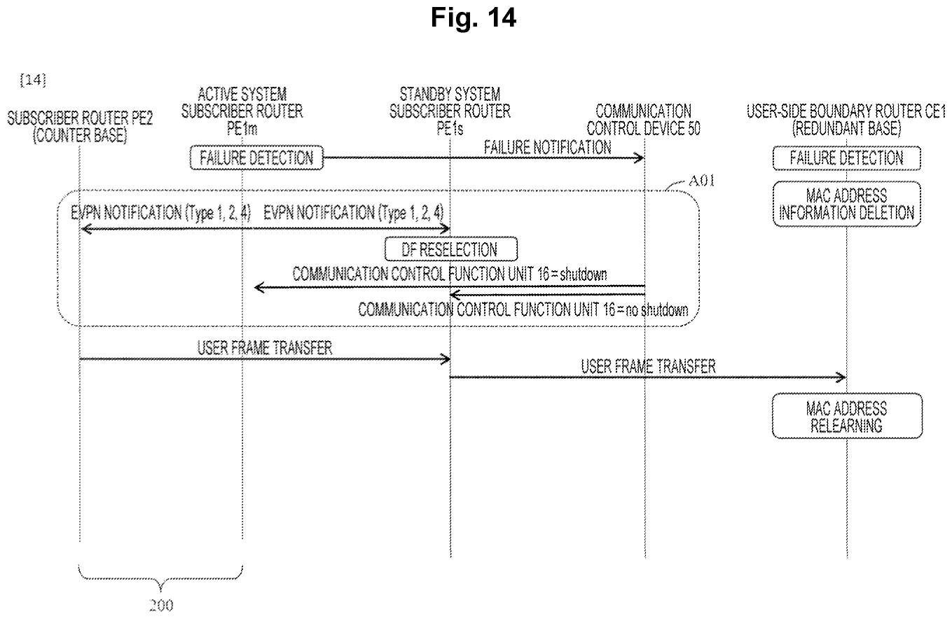

FIG. 14 is a sequence diagram illustrating an example in which the subscriber router in a redundant base has device redundancy, and redundancy switching (switching from the active system to the standby system) is performed by All-active of EVPN multihoming. Here, in operation A01, since high-speed switching is performed, EVPN notification and DF reselection are performed almost simultaneously, and at the same time, opening/closing of the subscriber router (PE1m, PE1s) is also performed.

### Example 2

This example is a case of transition from the state P0 to the state P1.

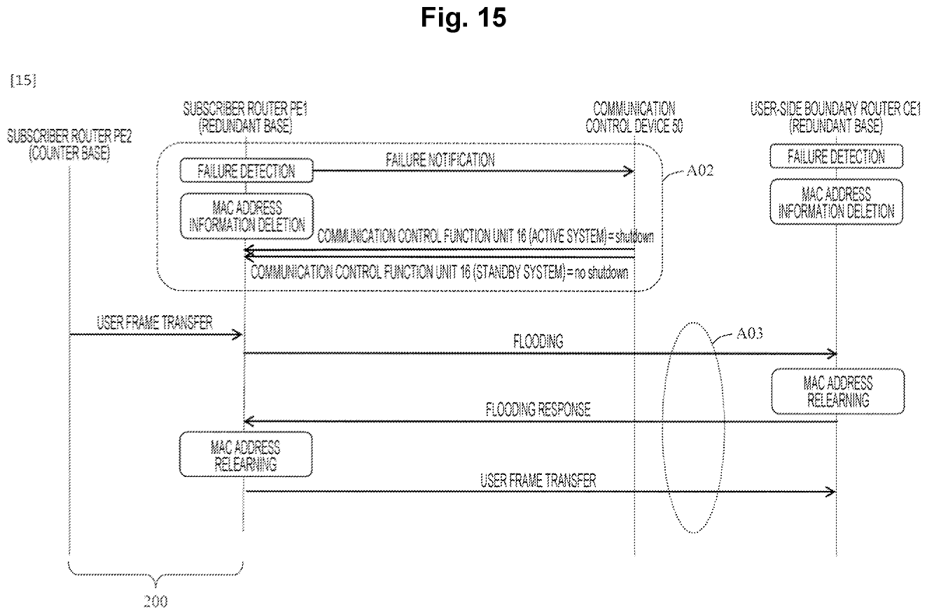

FIG. 15 is a sequence diagram illustrating an example in which the subscriber router in the redundant base is in the case of the line card redundancy, a bridge connection is made between the PE and the CE, and redundancy switching (switching from the active system to the standby system) is performed by MAC address relearning. Here, in operation A02, in switching from the active system to the standby system, communication with the subscriber router PE2 in the opposite base does not occur, so that communication control can be immediately performed from failure detection. Note that, in operation A03, in a case where uplink traffic arrives at the user-side boundary router CE1 before a user frame from the subscriber router PE2 in the opposite base, flooding is performed from the user-side boundary router CE1 to the subscriber router PE1, and a flooding response arrives from the subscriber router PE1, so that the user-side boundary router CE1 relearns a MAC address.

### Example 3

This example is a case of transition from the state P1 to the state P0.

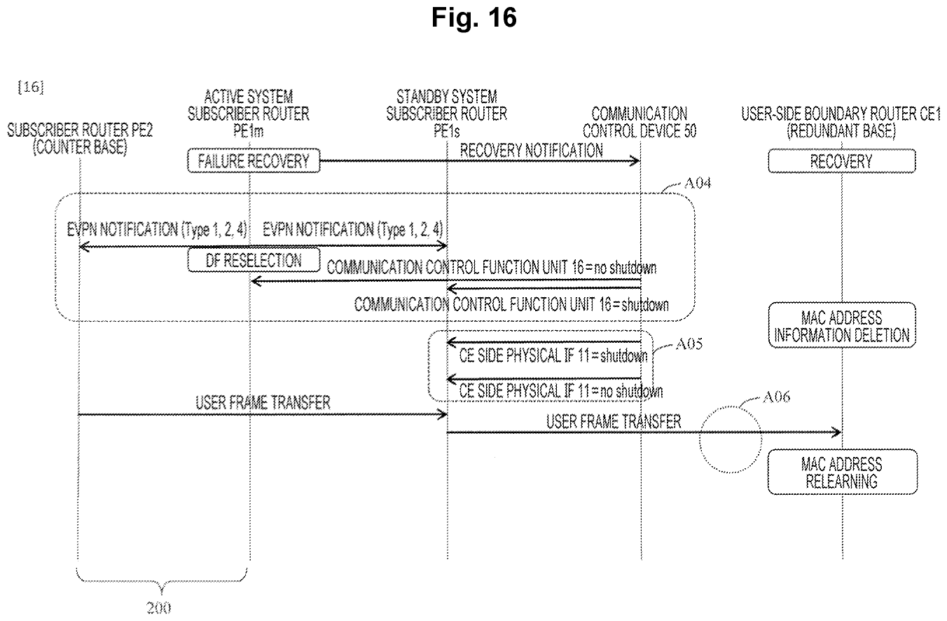

FIG. 16 is a sequence diagram illustrating an example in which the subscriber router in the redundant base has device redundancy, and switch-back (switching from the standby system to the active system) is performed by All-active of EVPN multihoming. Here, in operation A04, EVPN notification and DF reselection are performed almost simultaneously, and at the same time, opening/closing of the subscriber router (PE1m, PE1s) is also performed. Operation A05 is operation for avoiding an event in which the user-side boundary router CE1 that does not notice that the standby system subscriber router PE1s is closed continues to transfer a frame toward the subscriber router PE1s. Specifically, first, the CE-side physical interface 11 of the standby system subscriber router PE1s is forcibly shut down, and the user-side boundary router CE1 is caused to detect link disconnection. As a result, frame transfer from the user-side boundary router CE1 to the standby system subscriber router PE1s is canceled. However, when the forced shotdown is continued, it is difficult to distinguish between disconnection for redundancy and link disconnection between the PE and the CE due to a failure, on the operation side (management side of the communication system). Thus, to make it possible to detect the link disconnection due to the failure, the CE-side physical interface 11 of the standby system subscriber router PE1s is restored to the no shutdown state again. Note that, in operation A06, in a case where uplink traffic arrives at the user-side boundary router CE1 before a user frame from the subscriber router PE2 in the opposite base, flooding is performed from the user-side boundary router CE1 to the subscriber router PE1, and a flooding response arrives from the subscriber router PE1, so that the user-side boundary router CE1 relearns a MAC address.

### Example 4

This example is a case of transition from the state P1 to the state P0.

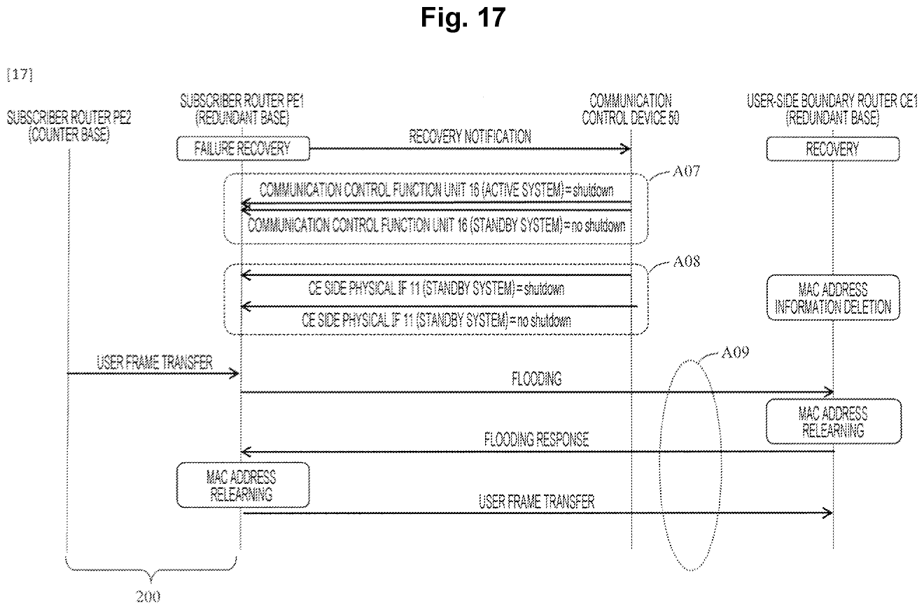

FIG. 17 is a sequence diagram illustrating an example in which the subscriber router in the redundant base is in the case of the line card redundancy, a bridge connection is made between the PE and the CE, and switch-back (switching from the standby system to the active system) is performed by MAC address relearning. Here, in operation A07, in switching from the standby system to the active system, communication with the subscriber router PE2 in the opposite base does not occur, so that communication control is performed immediately after failure recovery. Operation A08 is operation for avoiding an event in which the user-side boundary router CE1 that does not notice that the standby system line card is closed continues to transfer a frame toward the standby system line card (operation similar to the operation A05). Note that, in operation A09, in a case where uplink traffic arrives at the user-side boundary router CE1 before a user frame from the subscriber router PE2 in the opposite base, flooding is performed from the user-side boundary router CE1 to the subscriber router PE1, and a flooding response arrives from the subscriber router PE1, so that the user-side boundary router CE1 relearns a MAC address.

### Example 5

This example is a case of transition from the state P0 to the state P1.

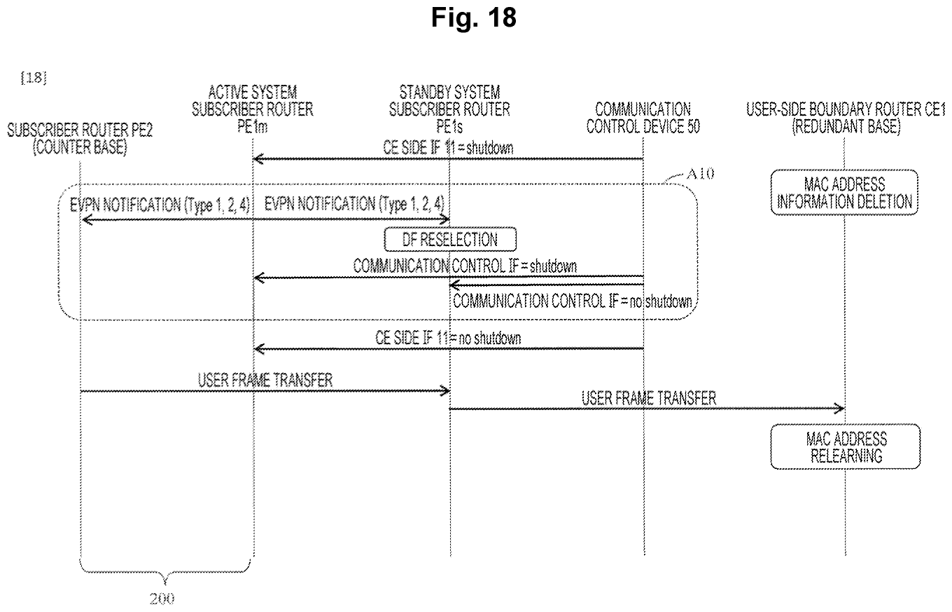

FIG. 18 is a sequence diagram illustrating an example in which the subscriber router in the redundant base has device redundancy, and manual switching (switching from the active system to the standby system) using the communication control method of the present invention is performed in All-active of EVPN multihoming. Here, in operation A10, since high-speed switching is performed, EVPN notification and DF reselection are performed almost simultaneously, and at the same time, opening/closing of the subscriber router (PE1m, PE1s) is also performed.

### Example 6

This example is a case of transition from the state P0 to the state P1.

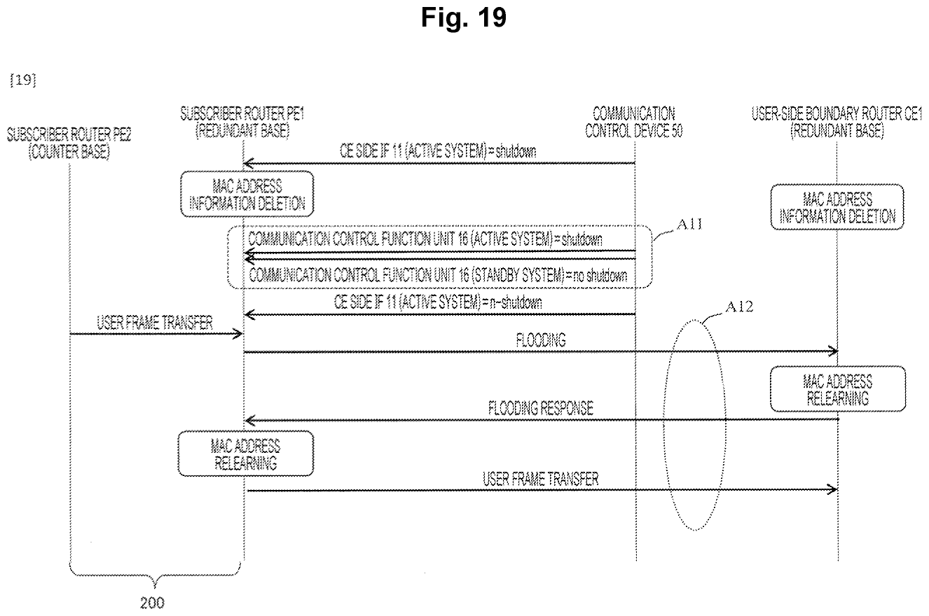

FIG. 19 is a sequence diagram illustrating an example in which the subscriber router in the redundant base is in the case of the line card redundancy, a bridge connection is made between the PE and the CE, and manual switching (switching from the active system to the standby system) is performed by MAC address relearning. Here, in operation A11, in switching from the active system to the standby system, communication with the subscriber router PE2 in the opposite base does not occur, so that communication control can be immediately performed from failure detection. Note that, in operation A12, in a case where uplink traffic arrives at the user-side boundary router CE1 before a user frame from the subscriber router PE2 in the opposite base, flooding is performed from the user-side boundary router CE1 to the subscriber router PE1, and a flooding response arrives from the subscriber router PE1, so that the user-side boundary router CE1 relearns a MAC address.

### Example 7

This example is a case of transition from the state P1 to the state P0 via the state P4.

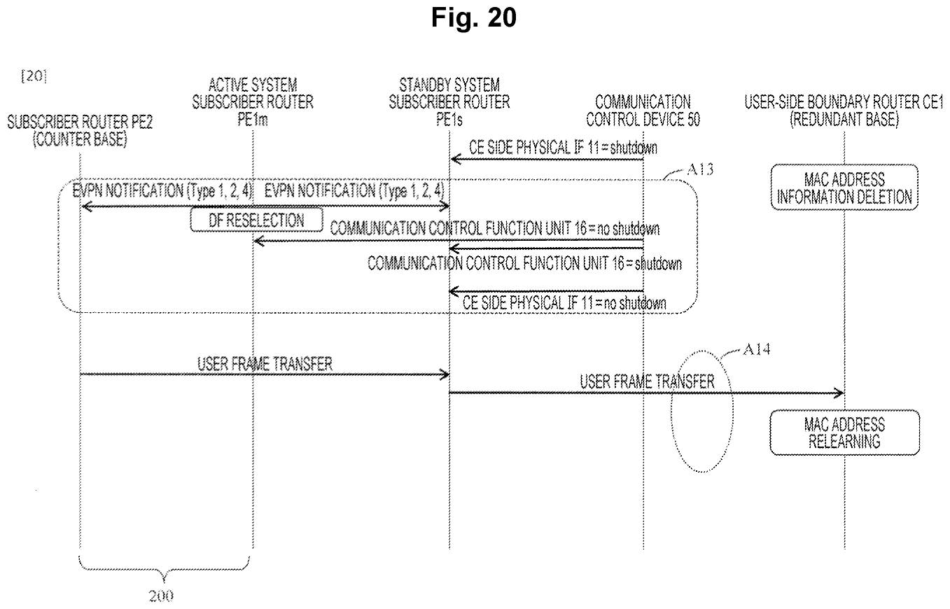

FIG. 20 is a sequence diagram illustrating an example in which the subscriber router in the redundant base has device redundancy, and manual switch-back (switching from the standby system to the active system) using the communication control method of the present invention is performed in All-active of EVPN multihoming. Here, in operation A13, EVPN notification and DF reselection are performed almost simultaneously, and at the same time, opening/closing of the subscriber router (PE1m, PE1s) is also performed. Note that, in operation A14, in a case where uplink traffic arrives at the user-side boundary router CE1 before a user frame from the subscriber router PE2 in the opposite base, flooding is performed from the user-side boundary router CE1 to the subscriber router PE1, and a flooding response arrives from the subscriber router PE1, so that the user-side boundary router CE1 relearns a MAC address.

### Example 8

This example is a case of transition from the state P1 to the state P0 via the state P4.

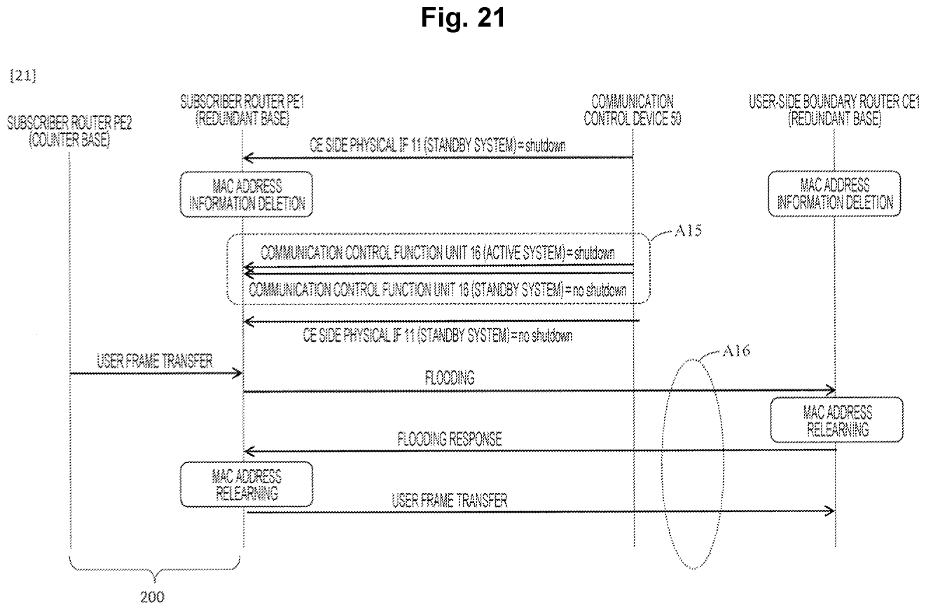

FIG. 21 is a sequence diagram illustrating an example in which the subscriber router in the redundant base is in the case of the line card redundancy, a bridge connection is made between the PE and the CE, and manual switch-back (switching from the standby system to the active system) is performed in a form of performing MAC address relearning. Here, in operation A15, in switching from the standby system to the active system, communication with the subscriber router PE2 in the opposite base does not occur, so that communication control is performed immediately after failure recovery. Note that, in operation A16, in a case where uplink traffic arrives at the user-side boundary router CE1 before a user frame from the subscriber router PE2 in the opposite base, flooding is performed from the user-side boundary router CE1 to the subscriber router PE1, and a flooding response arrives from the subscriber router PE1, so that the user-side boundary router CE1 relearns a MAC address.

### Example 9

This example is a case of transition between the state P0 and the state P2, that is, a case of standby system failure or standby system recovery. Since it is not necessary to link a flow of user traffic from the relay network 200 with operation of the communication control function unit 16, the communication control device 50 and the relay network 200 do not perform cooperative operation. In addition, since there is no switching of the communication control function unit 16, the state P2 of this example is the same as the steady state P0.

### Example 10

This example is an example of a case of transition from the state P1 to the state P3 or a case of transition from the state P2 to the state P3. That is, this example is a case where both the active system and the standby system transition to non-communication. Since it is not necessary to link a flow of user traffic from the relay network 200 with operation of the communication control function unit 16, the communication control device 50 and the relay network 200 do not perform cooperative operation, and only the communication control function units 16 of the active system and the standby system are shut down. However, in a case where the subscriber router PE1 in the redundant base has device redundancy, an EVPN notification is transmitted from the subscriber router PE1 that transitions to non-communication last in the active system/standby system to the subscriber router PE2 in the opposite base.

### Example 11

This example is a case of transition from the state P3 to the state P1.

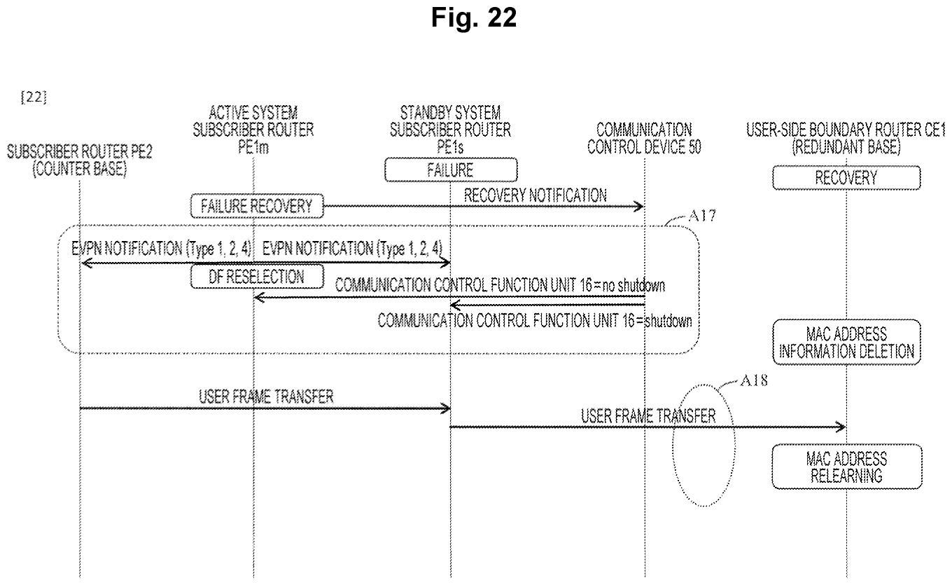

FIG. 22 is a sequence diagram illustrating an example in which the subscriber router in the redundant base has device redundancy, and the active system is recovered from a state where both the systems are disconnected in All-active of EVPN multihoming. Here, in operation A17, EVPN notification and DF reselection are performed almost simultaneously, and at the same time, opening/closing of the subscriber router (PE1m, PE1s) is also performed. Note that, in operation A18, in a case where uplink traffic arrives at the user-side boundary router CE1 before a user frame from the subscriber router PE2 in the opposite base, flooding is performed from the user-side boundary router CE1 to the subscriber router PE1, and a flooding response arrives from the subscriber router PE1, so that the user-side boundary router CE1 relearns a MAC address.

### Example 12

This example is a case of transition from the state P3 to the state P1.

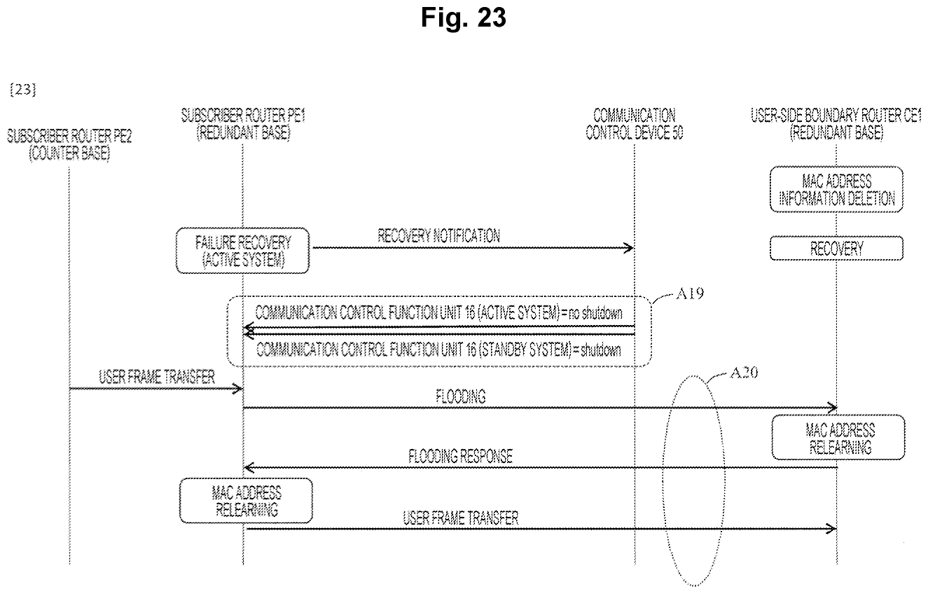

FIG. 23 is a sequence diagram illustrating an example in which the subscriber router in the redundant base is in the case of the line card redundancy, a bridge connection is made between the PE and the CE, and the active system is recovered by MAC address relearning from a state where both the systems are disconnected. Here, in operation A19, in recovery of the active system, communication with the subscriber router PE2 in the opposite base does not occur, so that communication control is performed immediately after failure recovery. Note that, in operation A20, in a case where uplink traffic arrives at the user-side boundary router CE1 before a user frame from the subscriber router PE2 in the opposite base, flooding is performed from the user-side boundary router CE1 to the subscriber router PE1, and a flooding response arrives from the subscriber router PE1, so that the user-side boundary router CE1 relearns a MAC address.

### Example 13

This example is a case of transition from the state P3 to the state P2.

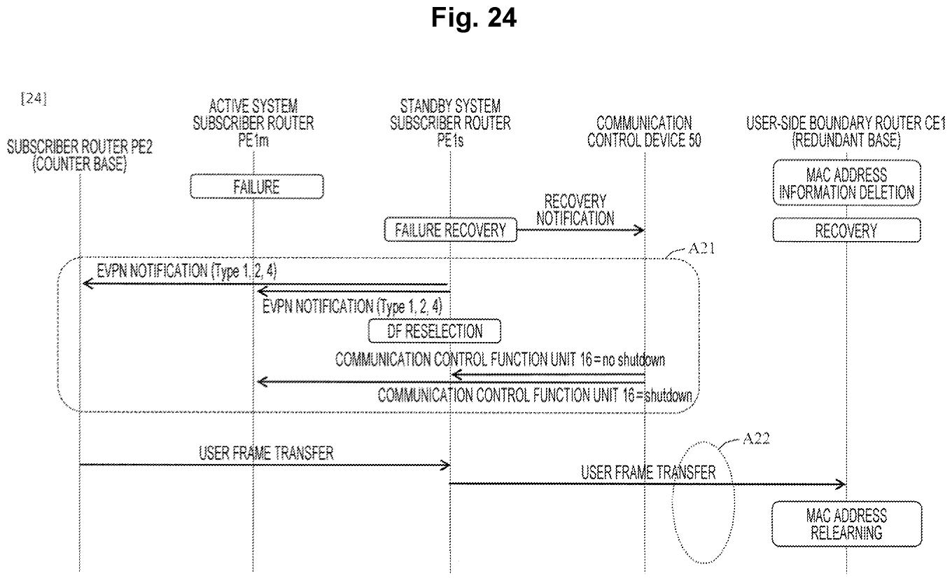

FIG. 24 is a sequence diagram illustrating an example in which the subscriber router in the redundant base has device redundancy, and the standby system is recovered from a state where both the systems are disconnected in All-active of EVPN multihoming. Here, in operation A21, the EVPN notification and DF reselection are performed almost simultaneously, and at the same time, opening/closing of the subscriber router (PE1m, PE1s) is also performed. Note that, in operation A22, in a case where uplink traffic arrives at the user-side boundary router CE1 before a user frame from the subscriber router PE2 in the opposite base, flooding is performed from the user-side boundary router CE1 to the subscriber router PE1, and a flooding response arrives from the subscriber router PE1, so that the user-side boundary router CE1 relearns a MAC address.

### Example 14

This example is a case of transition from the state P3 to the state P2.

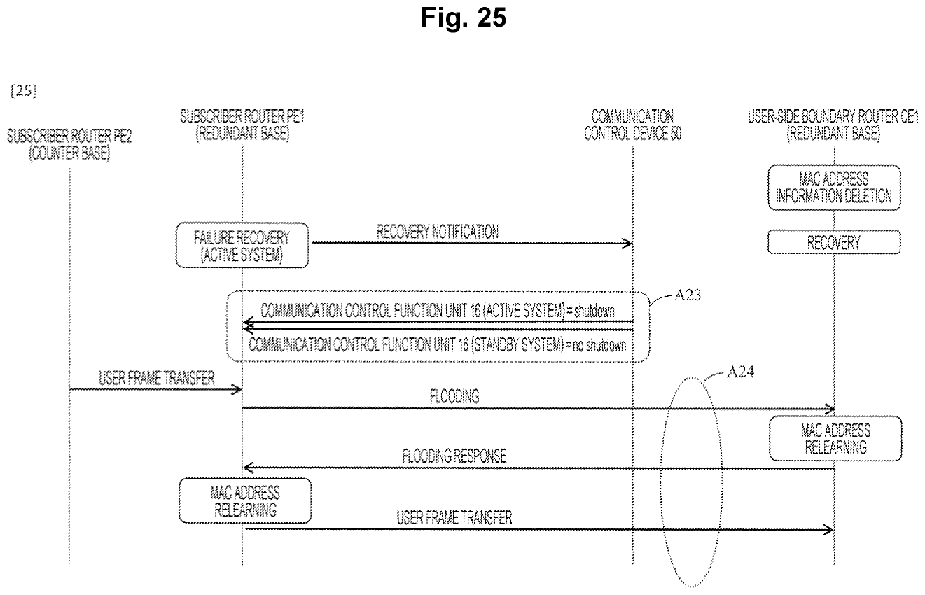

FIG. 25 is a sequence diagram illustrating an example in which the subscriber router in the redundant base is in the case of the line card redundancy, a bridge connection is made between the PE and the CE, and the standby system is recovered by MAC address relearning from a state where both the systems are disconnected. Here, in operation A23, in recovery of the standby system, communication with the subscriber router PE2 in the opposite base does not occur, so that communication control is performed immediately after failure recovery. Note that, in operation A24, in a case where uplink traffic arrives at the user-side boundary router CE1 before a user frame from the subscriber router PE2 in the opposite base, flooding is performed from the user-side boundary router CE1 to the subscriber router PE1, and a flooding response arrives from the subscriber router PE1, so that the user-side boundary router CE1 relearns a MAC address.

(Embodiment of Program)

The communication control device 50 can also be implemented by a computer and a program, and the program can be recorded in a recording medium or provided through a network.

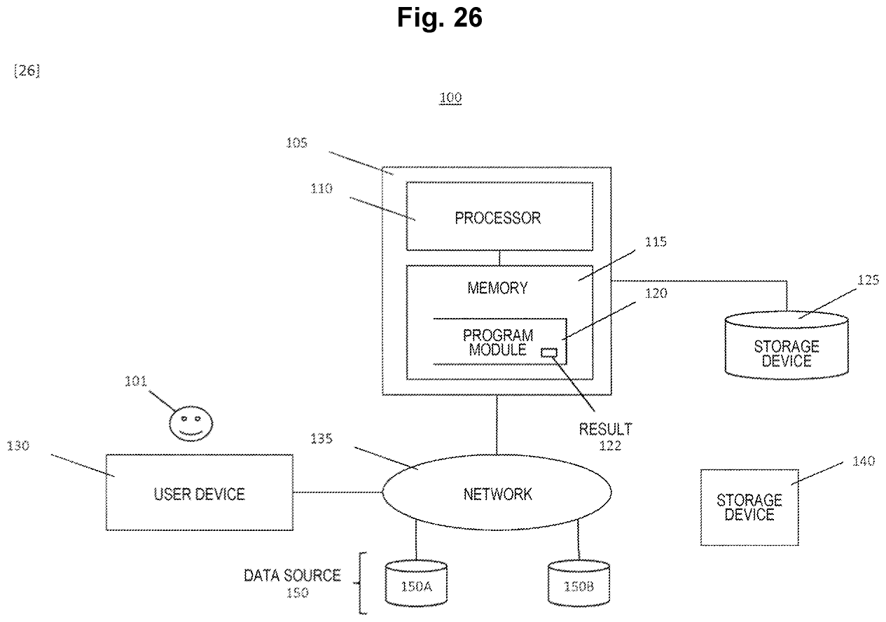

FIG. 26 illustrates a block diagram of a system 100. The system 100 includes a computer 105 connected to a network 135.

The network 135 is a data communication network. The network 135 may be a private network or a public network, and may include any or all of (a) a personal area network, for example, covering a room, (b) a local area network, for example, covering a building, (c) a campus area network, for example, covering a campus, (d) a metropolitan area network, for example, covering a city, (e) a wide area network, for example, covering an area connected across boundaries of cities, rural areas, or the countries, or (f) the Internet. Communication is performed by an electronic signal and an optical signal via the network 135.

The computer 105 includes a processor 110 and a memory 115 connected to the processor 110. The computer 105 is represented herein as a standalone device, but is not limited in this way, and rather may be connected to other devices (not illustrated) in a distributed processing system.

The processor 110 is an electronic device including logic circuitry that responds to and executes instructions.

The memory 115 is a tangible computer readable storage medium in which a computer program is encoded. In this regard, the memory 115 stores data and instructions, i.e., program codes, that are readable and executable by the processor 110 to control operation of the processor 110. The memory 115 may be implemented by a random access memory (RAM), a hard drive, a read-only memory (ROM), or a combination thereof. One of the components of the memory 115 is a program module 120.

The program module 120 includes instructions for controlling the processor 110 to execute processes described herein. In the present description, it is described that operations are executed by the computer 105 or a method or a process or a sub-process thereof; however, the operations are actually executed by the processor 110.

The term “module” is used herein to refer to a functional operation that may be embodied either as a standalone component or as an integrated configuration of a plurality of sub-components. Thus, the program module 120 can be implemented as a single module or as a plurality of modules that operate in cooperation with each other. Furthermore, although the program module 120 is described herein as being installed in the memory 115 and thus implemented in software, the program module can be implemented in any of hardware (for example, an electronic circuit), firmware, software, or a combination thereof.

Although shown as already loaded into the memory 115, the program module 120 may be configured to be located on a storage device 140 so as to be subsequently loaded into the memory 115. The storage device 140 is a tangible computer readable storage medium that stores the program module 120. Examples of the storage device 140 include a compact disk, magnetic tape, a read-only memory, an optical storage medium, a hard drive or a memory unit including a plurality of parallel hard drives, and a Universal Serial Bus (USB) flash drive. Alternatively, the storage device 140 may be a random access memory or another type of electronic storage device located in a remote storage system (not illustrated) and connected to the computer 105 via the network 135.

The system 100 described herein further includes a data source 150A and a data source 150B collectively referred to as a data source 150, and communicably connected to the network 135. In practice, the data source 150 can include any number of data sources, i.e., one or more data sources. The data source 150 includes unorganized data and can include social media.

The system 100 further includes a user device 130 operated by a user 101 and connected to the computer 105 via the network 135. The user device 130 includes an input device, such as a keyboard or a voice recognition subsystem, for enabling the user 101 to communicate information and command selections to the processor 110. The user device 130 further includes an output device such as a display device, a printer, or a speech synthesizer. A cursor control unit, such as a mouse, trackball, or touch-sensitive screen, allows the user 101 to manipulate a cursor on the display device to communicate further information and command selections to the processor 110.

The processor 110 outputs a result 122 of execution of the program module 120 to the user device 130. Alternatively, the processor 110 can provide the output to a storage device 125, for example, a database or memory, or to a remote device (not illustrated) via the network 135.

For example, a program that performs the flowchart of FIG. 7, FIG. 10, or FIG. 12 may be used as the program module 120. The system 100 can be operated as the communication control device 50.

The term “include . . . ” or “including . . . ” refers to the features, integers, steps, or a component mentioned is present, but should be construed as not excluding that one or more other features, integers, steps, or components or groups thereof are present. The terms “a” and “an” are indefinite articles for an object and therefore do not exclude embodiments having a plurality of the objects.

### Other Embodiments

Note that the present invention is not limited to the above embodiments, and various modifications can be made without departing from the gist of the present invention. In short, the present invention is not limited to the high-order embodiment as it is, and in the implementation stage, the components can be modified and embodied without departing from the gist thereof.

In addition, various inventions can be made by appropriately combining a plurality of components disclosed in the above embodiments. For example, some components may be deleted from all the components shown in the embodiments. Furthermore, components in different embodiments may be appropriately combined.

### REFERENCE SIGNS LIST

11 CE-side physical interface
12 sub-interface
13 bridge domain
14 encapsulation function unit
15 relay-network-side physical interface
16 communication control function unit
50 communication control device
51 detection unit
52 control determination unit
53 Switching control unit
54 switching setting unit
55 state transition recording unit
56 operation state storage unit
57 error detection unit
58 switch-back setting unit
59 instruction receiving unit
100 system
101 user
105 computer
110 processor
115 memory
120 program module
122 result
125 storage device
130 user device
135 network
140 storage device
150 data source
200 relay network
201 redundant section

1. A communication control device that controls a subscriber router that makes an access section between a relay network and a user device redundant with an active system and a standby system,
the communication control device comprising,
in order to cause a communication control function unit to perform transition of a communication state, in the subscriber router, the communication control function unit grasping the communication state between the active system and the standby system and also opening or closing the active system and opening or closing the standby system to perform the transition of the communication state,
a detection unit that detects alarm information on failure or recovery of the active system and the standby system,
an operation state storage unit that stores the communication state at present after the communication control function unit has made the transition of the communication state,
a control determination unit that determines the communication state that is new in the subscriber router on a basis of the alarm information detected by the detection unit and information on the communication state stored in the operation state storage unit,
a switching setting unit that sets the communication state that is new determined by the control determination unit for the communication control function unit, and
a state transition recording unit that stores the communication state that is new determined by the control determination unit in the operation state storage unit.

2. The communication control device according to claim 1, further comprising
an error detection unit that detects an error during the transition of the communication state performed by the communication control function unit, and
a switch-back setting unit that performs setting on the communication control function unit when the error is detected to restore the communication state that is new to the communication state that is an original state.

3. The communication control device according to claim 1, further comprising an instruction receiving unit that instructs the switching setting unit to perform setting to restore the communication state transitioned, to an original state when an instruction signal externally input is received.

4. A communication system comprising the communication control device according to claim 1, and the subscriber router.

5. A communication control method for controlling a subscriber router that makes an access section between a relay network and a user device redundant with an active system and a standby system,
the communication control method comprising,
in order to cause a communication control function unit to perform transition of a communication state, in the subscriber router, the communication control function unit grasping the communication state between the active system and the standby system and also opening or closing the active system and opening or closing the standby system to perform the transition of the communication state,
detecting alarm information on failure or recovery of the active system and the standby system,
determining the communication state that is new in the subscriber router on a basis of the alarm information and information on the communication state at present stored in an operation state storage unit,
setting the communication state that is new for the communication control function unit, and
storing the communication state that is new in the operation state storage unit.

6. The communication control method according to claim 5, further comprising
detecting an error during the transition of the communication state performed by the communication control function unit, and
performing setting on the communication control function unit when the error is detected to restore the communication state that is new to the communication state that is an original state.

7. The communication control method according to claim 5, further comprising performing setting to restore the communication state transitioned, to an original state when an instruction signal externally input is received.

8. A non-transitory computer-readable medium having computer-executable instructions that, upon execution of the instructions by a processor of a computer, cause the computer to function as the communication control device according to claim 1.
